(19) United States
(12) Patent Application Publication
(10) Pub. No.: US 2019/0095301 A1
(43) Pub. Date: Mar. 28, 2019

(54) METHOD FOR DETECTING ABNORMAL SESSION

(71) Applicant: Penta Security Systems Inc., Seoul (KR)

(72) Inventors: Sang Gyoo SIM, Seoul (KR); Duk Soo KIM, Seoul (KR); Seok Woo LEE, Seoul (KR); Seung Young PARK, Chuncheon-si (KR)

(21) Appl. No.: 15/908,594

(22) Filed: Feb. 28, 2018

(30) Foreign Application Priority Data
Sep. 22, 2017 (KR) 10-2017-0122363

(51) Int. Cl. G06F 11/22; G06N 3/04; G06N 3/08

(52) U.S. Cl. CPC G06F 11/2263; G06N 3/0445; G06N 3/08; G06N 3/0454; G06N 3/04

(57) ABSTRACT

Provided is a method for detecting an abnormal session including a request message received by a server from a client and a response message generated by the server, the method including transforming at least a part of messages included in the session into data in the form of a matrix, transforming the data in the form of the matrix into a representation vector a dimension of which is lower than a dimension of the matrix of the data using a convolutional neural network, and determining whether the session is abnormal by arranging the representation vectors obtained from the messages in an order in which the messages are generated to compose a first representation vector sequence, and analyzing the first to representation vector sequence using an long short term memory (LSTM) neural network.

### CLAIM FOR PRIORITY

This application claims priority to Korean Patent Application No. 2017-0122363 filed on Sep. 22, 2017 in the Korean Intellectual Property Office (KIPO), the entire contents of which are hereby incorporated by reference.

### BACKGROUND

### 1. Technical Field

Example embodiments of the present invention generally relate to the field of a method for detecting an abnormal session of a server, and more specifically, to a method for detecting an abnormal session using a convolutional neural network and a long short-term memory (LSTM) neural network.

### 2. Related Art

In general, while a server provides a client with a service, the client transmits request messages (e.g., http requests) to the server, and the server generates response messages (e.g., an http response) in response to the requests. The request messages and the response messages generated in the service providing process are arranged according to a time sequence, and the arranged messages are referred to as a session (e.g., an http session).

When an error occurs in an operation of the server or an attacker gains access by highjacking login information of another user, the arrangement feature of the request messages and the response message is different than usual, thereby producing an abnormal session having a feature different from that of a normal session. In order to rapidly recover a service error, a technology for monitoring sessions and detecting an abnormal session is needed. Meanwhile, as a technology of automatically extracting a feature of data and categorizing the data, machine learning is garnering attention.

Machine learning is a type of artificial intelligence (AI), in which a computer performs predictive tasks, such as regression, classification, and clustering on the basis of data learned by itself.

Deep learning is a field of the machine learning, in which a computer is trained to have a human's way of thinking, and which is defined as a set of machine learning algorithms that attempt a high-level abstraction (a task of abstracting key contents or functions in a large amount of data or complicated material) through a combination of non-linear transformation techniques.

A deep learning structure is a concept designed based on artificial neural networks (ANNs). The ANN is an algorithm that mathematically models a virtual neuron and simulates the virtual neuron such that the virtual neuron is provided with a learning capability similar to that of a human's brain, and in many cases, an ANN is used for pattern recognition. An artificial neural network model used in the deep learning has a structure in which linear fitting and nonlinear transformation or activation are repeatedly stacked. The neural network model used in the deep learning includes a deep neural network (DNN), a convolutional neural network (CNN), a recurrent neural network (RNN), a restricted Boltzmann machine (RBM), a deep belief network (DBN), a deep Q-network, or the like.

### SUMMARY

Accordingly, example embodiments of the present invention are provided to substantially obviate one or more problems due to limitations and disadvantages of the related art.

Example embodiments of the present invention provide a method for detecting an abnormal session using an artificial neural network.

In some example embodiments, a method for detecting an abnormal session including a request message received by a server from a client and a response message generated by the server includes: transforming at least a part of messages included in the session into data in the form of a matrix; transforming the data in the form of the matrix into a representation vector, a dimension of which is lower than a dimension of the matrix of the data using a convolutional neural network; and determining whether the session is abnormal by arranging the representation vectors obtained from the messages in an order in which the messages are generated to compose a first representation vector sequence, and analyzing the first representation vector sequence using an long short term memory (LSTM) neural network.

The transforming of the at least a part of the messages into the data in the form of the matrix may include transforming each of the messages into data in the form of a matrix by transforming a character included in each of the messages into a one-hot vector.

The LSTM neural network may include an LSTM encoder including a plurality of LSTM layers and an LSTM decoder having a structure symmetrical to the LSTM encoder.

The LSTM encoder may sequentially receive the representation vectors included in the first representation vector sequence and output a hidden vector having a predetermined magnitude, and the LSTM decoder may receive the hidden vector and output a second representation vector sequence corresponding to the first representation vector sequence.

The determining of whether the session is abnormal may include determining whether the session is abnormal on the basis of a difference between the first representation vector sequence and the second representation vector sequence.

The LSTM decoder may output the second representation vector sequence by outputting estimation vectors, each corresponding to one of the representation vectors included in the first representation vector sequence, in a reverse order to an order of the representation vectors included in the first representation vector sequence.

The LSTM neural network may sequentially receive the representation vectors included in the first representation vector sequence and output an estimation vector with respect to a representation vector immediately following the received representation vector.

The determining of whether the session is abnormal may include determining whether the session is abnormal on the basis of a difference between the estimation vector output by the LSTM neural network and the representation vector received by the LSTM neural network.

The method may further include training the convolutional neural network and the LSTM neutral network.

The convolutional neural network may be trained by inputting training data to the convolutional neural network; inputting an output of the convolutional neural network to a symmetric neural network having a structure symmetrical to the convolutional neural network; and updating weight parameters used in the convolutional neural network on the basis of a difference between the output of the symmetric neural network and the training data.

The LSTM neural network may include an LSTM encoder including a plurality of LSTM layers and an LSTM decoder having a structure symmetrical to the LSTM encoder, and the LSTM neural network may be trained by inputting training data to the LSTM encoder; inputting a hidden vector output from the LSTM encoder and the training data to the LSTM decoder; and updating weight parameters used in the LSTM encoder and the LSTM decoder on the basis of a difference between an output of the LSTM decoder and the training data.

In other example embodiments, a method for detecting an abnormal session including a request message received by a server from a client and a response message generated by the server includes: transforming at least a part of messages included in the session into data in the form of a matrix; transforming the data in the form of the matrix into a representation vector a dimension of which is lower than a dimension of the matrix of the data using a convolutional neural network; and determining whether the session is abnormal by arranging the representation vectors obtained from the messages in an order in which the messages are generated to compose a first representation vector sequence, and analyzing the first representation vector sequence using a gated recurrent unit (GRU) neural network.

The GRU neural network may include a GRU encoder including a plurality of GRU layers and a GRU decoder having a structure symmetrical to the GRU encoder.

The GRU encoder may sequentially receive the representation vectors included in the first representation vector sequence and output a hidden vector having a predetermined magnitude, and the GRU decoder may receive the hidden vector and output a second representation vector sequence corresponding to the first representation vector sequence.

The determining of whether the session is abnormal may include determining whether the session is abnormal on the basis of a difference between the first representation vector sequence and the second representation vector sequence.

The GRU decoder may output the second representation vector sequence by outputting estimation vectors, each corresponding to one of the representation vectors included in the first representation vector sequence, in a reverse order to an order of the representation vectors included in the first representation vector sequence.

The GRU neural network may sequentially receive the representation vectors included in the first representation vector sequence and output an estimation vector with respect to a representation vector immediately following the received representation vector.

The determining of whether the session is abnormal may include determining whether the session is abnormal on the basis of a difference between a prediction value output by the GRU neural network and the representation vector received by the GRU neural network.

### BRIEF DESCRIPTION OF DRAWINGS

Example embodiments of the present invention will become more apparent by describing example embodiments of the present invention in detail with reference to the accompanying drawings, in which:

FIG. 1 is a block diagram illustrating an apparatus according to an example embodiment;

FIG. 2 is a flowchart showing a method for detecting an abnormal session performed in the apparatus according to the example embodiment of the present invention;

FIG. 3 is a conceptual diagram illustrating an example of a session;

FIG. 4 is a conceptual diagram exemplifying a transformation from a string of a message into data in the form of a matrix;

FIG. 5 is a conceptual diagram exemplifying a convolutional neural network;

FIG. 6 is a conceptual diagram exemplifying a convolution operation;

FIG. 7 is a conceptual diagram illustrating a convolution image that is extracted from an image shown in FIG. 6 by a processor;

FIG. 8 is a conceptual diagram illustrating operations of a convolution layer and pooling layer shown in FIG. 5;

FIG. 9 is a conceptual diagram exemplifying a long short-term memory (LSTM) neural network;

FIG. 10 is a conceptual diagram exemplifying a configuration of an LSTM layer;

FIG. 11 is a conceptual diagram illustrating an operation method for an LSTM encoder;

FIG. 12 is a conceptual diagram illustrating an operation method for an LSTM decoder;

FIG. 13 is a conceptual diagram illustrating an example in which an LSTM neural network directly outputs an estimation vector;

FIG. 14 is a conceptual diagram exemplifying a GRU neural network;

FIG. 15 is a conceptual diagram exemplifying a configuration of a GRU layer;

FIG. 16 is a flowchart showing a modified example of a method for detecting an abnormal session performed in the apparatus (100) according to the example embodiment of the present invention; and

FIG. 17 is a conceptual diagram illustrating a training process of a convolutional neural network.

### DETAILED DESCRIPTION

While the present invention is susceptible to various modifications and alternative embodiments, specific embodiments thereof are shown by way of example in the drawings and will be described. However, it should be understood that there is no intention to limit the present invention to the particular embodiments disclosed, but on the contrary, the present invention is to cover all modifications, equivalents, and alternatives falling within the spirit and scope of the present invention.

It will be understood that, although the terms first, second, etc. may be used herein to describe various elements, the elements should not be limited by the terms. The terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items

It will be understood that when an element is referred to as being “connected” or “coupled” to another element, it can be directly connected or coupled to another element or intervening elements may be present. In contrast, when an element is referred to as being “directly connected” or “directly coupled” to another element, there are no intervening elements present.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms including technical and scientific terms and used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present invention will be described with reference to the accompanying drawings in detail. For better understanding of the present invention, same reference numerals are used to refer to the same elements through the description of the figures, and the description of the same elements will be omitted.

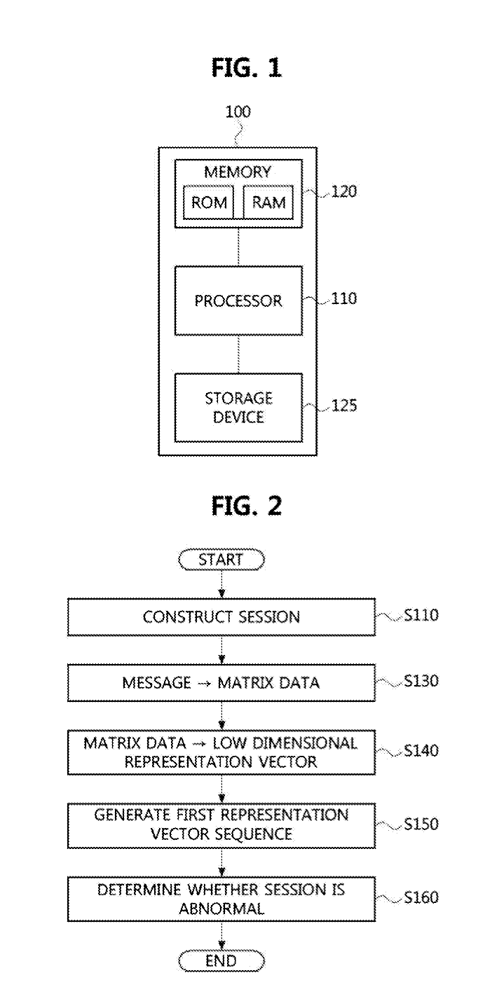

FIG. 1 is a block diagram illustrating an apparatus 100 according to an example embodiment.

The apparatus 100 shown in FIG. 1 may be a server that provides a service or an apparatus connected to the server and configured to analyze a session of the server.

Referring to FIG. 1, the apparatus 100 according to the example embodiment may include at least one processor 110, a memory 120, a storage device 125, and the like.

The processor 110 may execute a program command stored in the memory 120 and/or the storage device 125. The processor 110 may refer to a central processing unit (CPU), a graphics processing unit (GPU), or a dedicated processor by which the methods according to the present invention are performed. The memory 120 and the storage device 160 may include a volatile storage medium and/or a non-volatile storage medium. For example, the memory 120 may include a read only memory (ROM) and/or a random-access memory (RAM).

The memory 120 may store at least one command that is executed by the processor 110.

The commands stored in the memory 120 may be updated through machine learning of the processor 110. The processor 110 may change commands stored in memory through machine learning. The machine learning performed by the processor 110 may be implemented in a supervised learning method or an unsupervised learning method. However, the example embodiment is not limited thereto. For example, the machine learning may be implemented in other methods such as a reinforcement learning method and the like.

FIG. 2 is a flowchart showing a method for detecting an abnormal session performed in the apparatus 100 according to the example embodiment of the present invention.

Referring to FIG. 2, in operation S110, the processor 110 may construct a session. The processor 110 may construct a session from a request message sent by a client to a server and a response message generated by the server. The request message may include an http request. The response message may include the http response. The session may include the http session. The processor 110 may construct a session by sequentially arranging the request messages and the response messages according to the generation time.

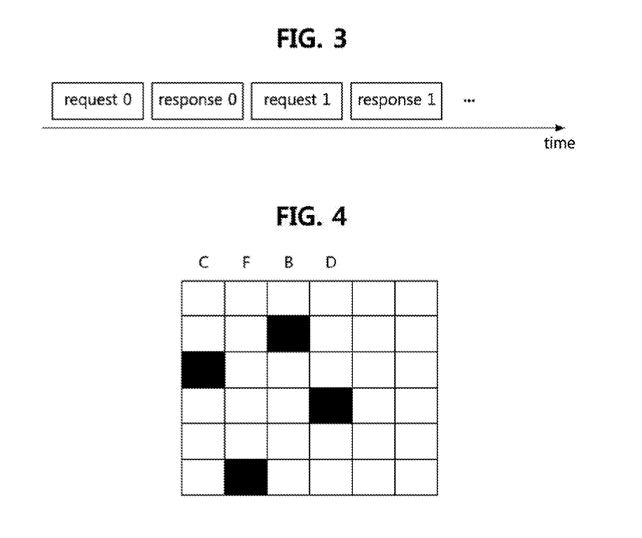

FIG. 3 is a conceptual diagram illustrating an example of a session.

Referring to FIG. 3, the processor 110 may construct a session by sequentially arranging request messages and response messages according to the generation time. The processor 110 may assign an identifier to each of the request messages and each of the response messages. The processor 110 may determine whether the session is abnormal by analyzing a feature of the session during a process described below. The processor 110 may determine the session in which the request messages and the response messages are arranged in an abnormal pattern to be an abnormal session by analyzing a feature of the session.

Referring again to FIG. 2, in operation S130, the processor 110 may extract at least a part of the messages included in the session. For example, the processor 110 may extract both the request message and the response message included in the session. As another example, the processor 110 may extract only the request message included in the session. As another example, the processor 110 may extract only the response message included in the session.

The processor 110 may transform each of the extracted messages into data in the form of a matrix. The processor 110 may transform a character included in each of the messages into a one-hot vector.

FIG. 4 is a conceptual diagram exemplifying that the processor 110 transforms a string of a message into data in the form of a matrix.

Referring to FIG. 4, the processor 110 may transform characters of a string included in the message into one-hot vectors in a reverse order starting from the last character of the string. The processor 110 may transform the string of the message into a matrix by transforming each of the characters into a one-hot vector.

The one-hot vector may include only one component having a value of one and the remaining components having a value of zero, or may include all components having a value of zero. In the one-hot vector, the position of a component having a value of ‘1’ may vary with the type of the character represented by the one hot vector. For example, as shown in FIG. 4, the one-hot vectors corresponding to the alphabets C, F, B, and D may vary in the positions of components having a value of ‘1’. The braille image shown in FIG. 4 is merely an example, and the example embodiment is not limited thereto. For example, the magnitude of the one-hot vector may be larger than that shown in FIG. 4. The one-hot vector may represent a text set “abcdefghijklmnopqrstuvwxyz0123456789-,;.!?:′\″∧\|_@#$%̂&*˜′+−=< >( )[ ]{ }.” Alternatively, in order to process various characters, an input string may be subjected to a UTF-8 code conversion and then to a hexadecimal conversion such that the input string is represented as “0123456789abcdef.” For example, a single alphabetic character subjected to these conversions is represented in two hexadecimal numbers.

In the one-hot vector, the position of a component having a value of 1 may vary with the order of the character represented by the one-hot vector.

When a total number of the types of characters is F⁽⁰⁾ (e.g., 69 (twenty-six alphabetic characters, ten numbers from zero to nine, new line, thirty-three special characters), the processor 110 may transform each message into a matrix having a magnitude of F⁽⁰⁾×L⁽⁰⁾. When the length of the message is smaller than L⁽⁰⁾, any of missing representation vectors may be transformed to a zero-representation vector. As another example, when the length of the message is larger than L⁽⁰⁾, only the characters corresponding in number to L⁽⁰⁾ may be transformed to one-hot vectors.

Referring again to FIG. 2, in operation S140, the processor 110 may map the matrix data to a low-dimensional representation vector using a convolutional neural network. The processor 110 may output a representation vector in which the characteristic of the matrix data is reflected using the convolutional neural network. The dimension of the output representation vector may be lower than the dimension of the matrix data. Hereinafter, the convolutional neural network will be described.

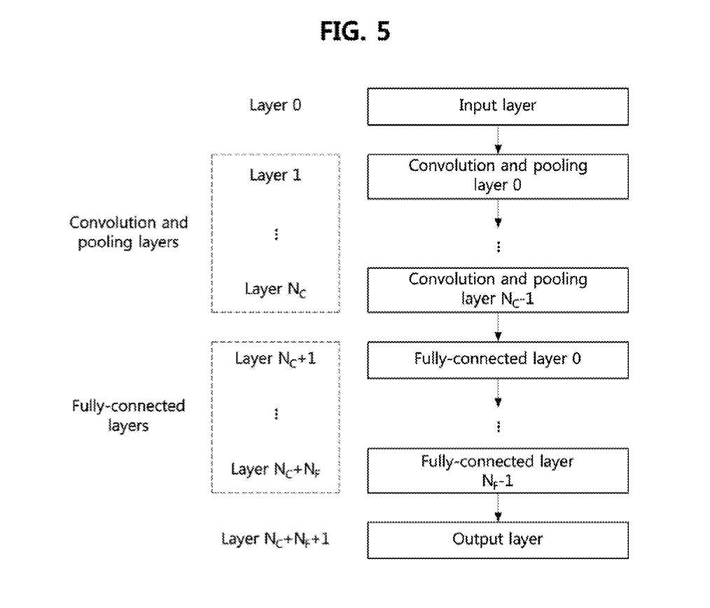

FIG. 5 is a conceptual diagram exemplifying a convolutional neural network.

Referring to FIG. 5, the convolutional neural network may include at least one convolution and pooling layer and at least one fully connected layer. Although FIG. 5 shows an example in which a convolution operation and a pooling operation are performed in one layer, the example embodiment is not limited thereto. For example, the layer in which the convolution operation is performed and the layer in which the pooling operation is performed may be separated from each other. In addition, the convolutional neural network may not perform the pooling operation.

The convolutional neural network may extract a feature of input data and generate output data having a scale smaller than that of the input data and output the generated output data. The convolutional neural networks may receive data in the form of an image or matrix.

The convolution and pooling layer may receive matrix data and perform the convolution operation on the received matrix data.

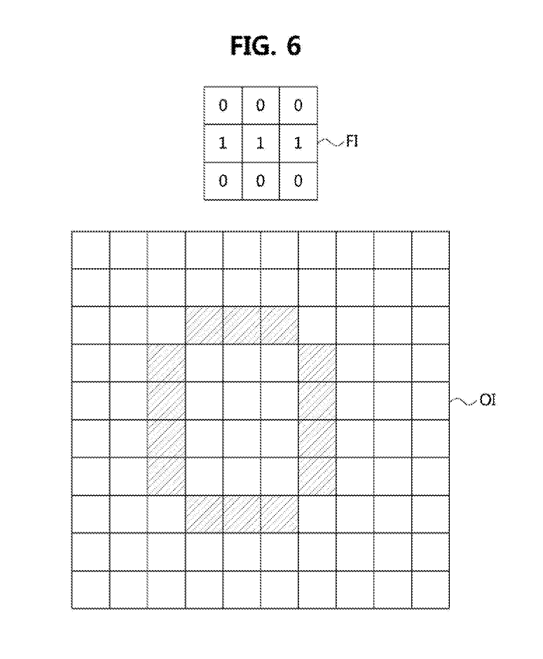

FIG. 6 is a conceptual diagram exemplifying a convolution operation.

Referring to FIG. 6, the processor 110 may perform a convolution operation on an input image 0I using a kernel FI. The kernel FI may be a matrix having a magnitude smaller than the number of pixels of the image 0I. For example, a component (1,1) of the filter kernel FI may be zero. Accordingly, when calculating the convolution, a pixel of the image 0I corresponding to the component (1,1) of the kernel FI may be multiplied by zero. As another example, a component (2,1) of the kernel FI is 1. Accordingly, when calculating the convolution, a pixel of the image 0I corresponding to the component (2,1) of the kernel FI may be multiplied by 1.

The processor 110 may perform the convolution operation on the image 0I while changing the position of the kernel FI on the image 0I. The processor 110 may output a convolution image from the calculated convolution values.

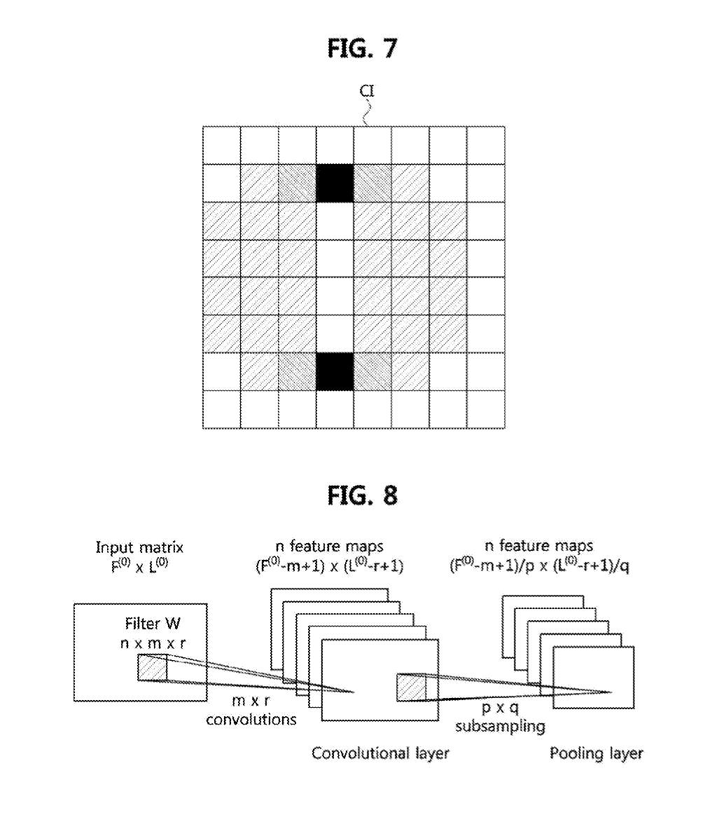

FIG. 7 is a conceptual diagram illustrating the convolution image that is extracted from the image 0I shown in FIG. 6 by the processor.

Since the number of cases in which the filter kernel FI shown in FIG. 6 moves on the image 0I is (10−3+1)×(10−3+1)=8×8, the processor 110 may calculate 8×8 convolution values, and extract an 8×8 pixel-sized convolution image as shown in FIG. 7 from the 8×8 convolution values. The number of pixels of the convolution image CI may become smaller than that of the original image OI. The processor 110 may extract the convolution image in which the feature of the original image is reflected using the kernel FI. The processor 110 may output the convolution image CI, which has a size smaller than that of the input image 01 and reflects a characteristic of the input image 01, using the kernel FI. The convolution operation may be performed at a convolution layer or at a convolution and pooling layer.

FIG. 8 is a conceptual diagram illustrating an operation of a convolution and pooling layer shown in FIG. 5.

In FIG. 8, for the sake of convenience, an operation of the first convolution and pooling layer (convolution and pooling layer 0) of the convolutional neural network is exemplarily shown. Referring to FIG. 8, an input layer may receive matrix data having a magnitude of F⁽⁰⁾×L⁽⁰⁾. The input layer may perform a convolution operation using n convolutional filters having a size of m×r. The input layer may output n feature maps through the convolution operation. The feature maps may each have a dimension smaller than that of F⁽⁰⁾×L⁽⁰⁾.

The convolution and pooling layer Layer 1 may perform a pooling operation on each of the feature maps output by the convolution operation, thereby reducing the size of the feature map. The pooling operation may be an operation of merging adjacent pixels in the feature map to obtain a single representative value. According to the pooling operation in the convolution and pooling layer, the size of the feature map may be reduced.

The representative value may be obtained in various methods. For example, the processor 110 may determine a maximum value among values of p×q adjacent pixels in the feature map to be the representative value. As another example, the processor 110 may determine the average value of values of p×q adjacent pixels in the feature map to be the representative value.

Referring again to FIG. 5, convolution and pooling operations may be performed by N_{c} convolution and pooling layers. As the convolution and pooling operations are performed, the size of the feature map may gradually decrease. In the last convolution and pooling layer Layer N_{c}, F^{(N}^{_{c}}⁾ feature maps having a size of M^{(N}^{_{c}}⁾×L^{(N}^{_{c}}⁾ may be output. The feature map output from the last convolution and pooling layer Layer Nc may be expressed as follows.

aₖ^{(N}^{_{c}}⁾(x,y) for 0≤k≤F^{N}^{_{c}}⁾−1,0≤x≤M^{(N}^{_{c}}⁾−1, and 0≤y≤L^{(N}^{_{c}}⁾−1

The feature maps output from the last convolution and pooling layer Layer Nc may be input to the first full connected layer Layer N_{c}+1. The first fully connected layer may transform the received feature maps to a one-dimensional representation vector a^{(N}^{_{c}}⁾(t) for 0≤t≤A^{(N}^{_{c}}⁾−1 having a magnitude of 1×F^{N}^{_{c}}⁾M^{(N}^{_{c}}⁾L^{(N}^{_{c}}⁾(≡^{(N}^{_{c}}⁾).

The first fully connected layer may multiply the transformed one-dimensional representation vector by a weight matrix. For example, the operation performed by the first fully connected layer may be represented by Equation 1.

$$\begin{matrix}{a}^{( {N}_{C} + 1 )} ( t ) = & {φ}^{( {N}_{C} + 1 )} \\ & ( {\sum }_{u = 0}^{{Λ}^{( {N}_{C} )} - 1} {W}^{( {N}_{C} + 1 )} ( t , u ) {a}^{( {N}_{C} )} ( u ) + {b}^{( {N}_{C} + 1 )} ( t ) ) \\ = & {φ}^{( {N}_{C} + 1 )} ( {z}^{( {N}_{C} + 1 )} ( t ) ) for 0 \leq t \leq {Λ}^{( {N}_{C} + 1 )} - 1\end{matrix} \qquad [ Equation 1 ]$$

In Equation 1, W^{(N}^{_{c}}⁺¹⁾(t, u) denotes a weight matrix used by the first fully connected layer. a^{(N}^{_{c}}⁺¹⁾(t) denotes a representation vector output from the first fully connected layer. a^{(N}^{_{c}}⁺¹⁾(t) may be a one-dimensional representation vector. N^{(N}^{_{c}}⁺¹⁾ denotes the magnitude of the representation vector a^{(N}^{_{c}}+1(t) output from the first fully connected layer.

Referring to Equation 1, the first fully connected layer may output the representation vector having a magnitude of A^{N}^{_{c}}⁺¹⁾ from the representation vector having a magnitude of A^{(N}^{_{c}}⁾ using the weight matrix.

Referring to FIG. 5, the convolutional neural network may include N_{F} fully connected layers. By generalizing Equation 1, the operation performed by the first fully connected layer may be expressed as Equation 2.

$$\begin{matrix}{a}^{( l )} ( t ) = {φ}^{( l )} ( {\sum }_{u = 0}^{{Λ}^{( l - 1 )} - 1} {W}^{( l )} ( t , u ) {a}^{( l - 1 )} ( u ) + {b}^{( l )} ( t ) ) \\ = {φ}^{( l )} ( {z}^{( l )} ( t ) ) for 0 \leq t \leq {Λ}^{( l )} - 1\end{matrix} \qquad [ Equation 2 ]$$

In Equation 2, a⁽¹⁾(t) denotes an output representation vector of the first fully connected layer. w^{(l)}(t, u) denotes the weight matrix used by the first fully connected layer. ϕ^{(l)} denotes an activation function used by the l^{th} fully connected layer. a^{(t-l)}(u) denotes the output representation vector of a l−1^{th} fully connected layer, and may be an input representation vector for the first fully connected layer.

An output layer may receive an output representation vector ^{a}^{^{(N}}^{_{c}}^{+N}^{ᵣ₎}^{(t)} of the last fully connected layer. The output layer may perform a representation vector operation as shown in Equation 3.

$${z}^{( {N}_{C} + {N}_{F} + 1 )} ( t ) = ( {\sum }_{u = 0}^{{Λ}^{( {N}_{C} + {N}_{F} )} - 1} {W}^{( {N}_{C} + {N}_{F} + 1 )} ( t , u ) {a}^{( {N}_{C} + {N}_{F} )} ( u ) + {b}^{( {N}_{C} + {N}_{F} + 1 )} ( t ) ) for 0 \leq t \leq C - 1 \qquad [ Equation 3 ]$$

In Equation 3, x^{(N}^{_{c}}^{+NF+1)}(t) denotes the representation vector output from the output layer. C denotes the number of classes of the output representation vector _{z}^{(N}^{_{c}}^{+N}^{_{f}}⁺¹⁾₍ₜ₎.

The output layer may calculate final output values for the classes of the output representation vector z^{(N}^{_{c}}^{+N}^{_{f}}⁺¹⁾(t) (t) obtained in Equation 3. The output layer may calculate a final output representation vector using an activation function. The process of calculating the final output values in the output layer may be expressed by Equation 4

\hat{γ}(t)=ϕ^{N}^{_{c}}^{+N}^{_{F}}⁺¹⁾(z^{(N}^{_{c}}^{+N}^{_{F}}⁺¹⁾(t)) [Equation 4]

In Equation 4, ϕ^{(N}^{_{c}}^{+N}^{_{F}}⁺¹⁾ denotes an activation function used in the output layer. ϕ^{(N}^{_{C}}^{+N}^{_{F}}⁺¹⁾ may be at least one of a sigmoid function, a hyper-tangent function, and a rectified linear unit. Referring to Equation 4, the output layer may calculate the final output representation vector \hat{γ}(t) for the output representation vector z^{(N}^{_{C}}^{+N}^{_{F}}⁺¹⁾(t).

As another example, the output layer may calculate the final output value using a softmax function. The process of calculating the final output representation vector in the output layer may be expressed by Equation 5.

$$\hat{γ} ( t ) = \frac{exp ( {z}^{( {N}_{C} + {N}_{F} + 1 )} ( t ) )}{{Σ}_{{t}^{′} = 0}^{C - 1} exp ( {z}^{( {N}_{C} + {N}_{F} + 1 )} ( {t}^{′} ) )} \qquad [ Equation 5 ]$$

Referring to Equation 5, the output layer may calculate the final output value using an exponential function for a class value of the output representation vector.

With 0≤c−1 shown in Equations 3 to 5, the convolutional neural network may output the representation vector having a magnitude of C×1. That is, the convolutional neural network may receive matrix data having a magnitude of F⁽⁰⁾×L⁽⁰⁾ and output the representation vector having a magnitude of C×1.

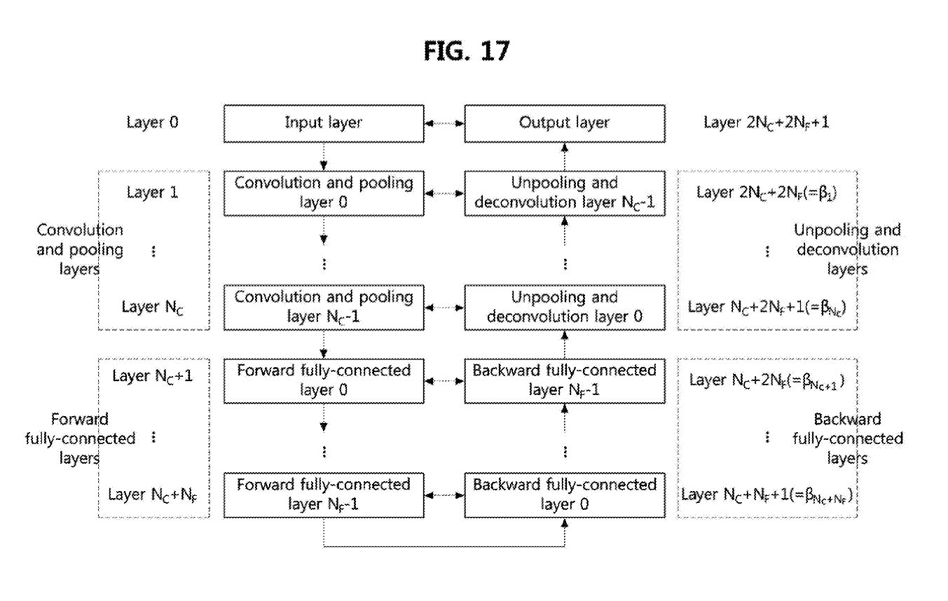

The convolutional neural network may also be trained by an unsupervised learning method. The training method for the convolutional neural network will be described below with reference to FIG. 17.

Referring again FIG. 2, in operation S150, the processor 110 may generate a first representation vector sequence corresponding to the session. The processor 110 may generate the first representation vector sequence using representation vectors each obtained from a corresponding one of the messages extracted in the session using the convolutional neural network. For example, the processor 110 may generate a representation vector sequence by sequentially arranging the representation vectors according to the generation order of the messages. The first representation vector sequence may be represented by way of example as follows.

x₀, x₁, . . . x_{S-1}

x₁ may denote a representation vector generated from a t^{th} message of the session (a request message or a response message).

In operation S160, the processor 110 may determine whether the session is abnormal by analyzing the first representation vector sequence. The processor 110 may analyze the first representation vector sequence using a long short-term memory (LSTM) neural network. The LSTM neural network may avoid a long-term dependence of a recurrent neural network (RNN) by selectively updating a cell state in which information is stored. Hereinafter, the LSTM neural network will be described.

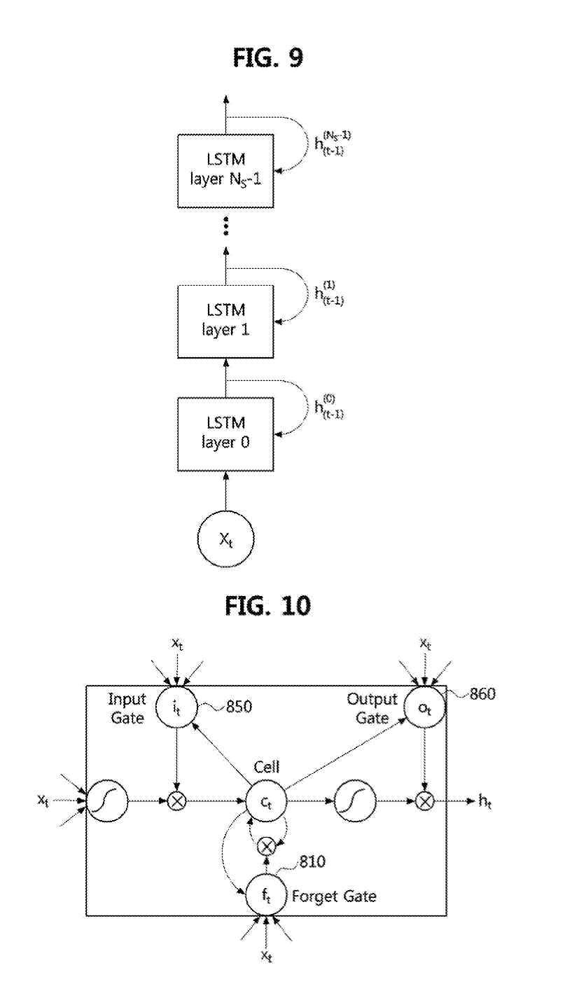

FIG. 9 is a conceptual diagram exemplifying an LSTM neural network.

Referring to FIG. 9, the LSTM neural network may include a plurality of LSTM layers. The LSTM neural network may receive a representation vector sequence. The LSTM neural network may sequentially receive representation vectors x₀, x₁, . . . x_{S-1} included in the representation vector sequence. A 0^{th} layer LSTM layer 0 of the LSTM neural network may receive a t^{th} representation vector ^{x}^{ₜ} and a hidden vector hₜ₋₁⁰ that is output by the 0^{th} layer LSTM layer 0 in response to receiving a vector ^{x}^{_{t−1}}. In order to output a hidden vector hₜ⁰ with respect to the t^{th} representation vector ^{x}^{ₜ}, the 0^{th} layer may use the hidden vector ^{h}^{_{t−1}}⁰ with respect to a previous representation vector. That is, the LSTM layer refers to the hidden vector output with respect to a previous representation vector when outputting the hidden vector with respect to an input representation vector, so that a correlation between the representation vectors of the sequence may be considered.

An n^{th} layer may receive a hidden vector hₜⁿ⁻¹ from an (n−1)^{th} layer. The n^{th} layer may output a hidden vector hₜⁿ by using the hidden vector hₜ₋₁ⁿ with respect to a previous representation vector and the hidden vector hₜⁿ⁻¹ received from the (n−1)^{th} layer.

Hereinafter, an operation of each of the layers of the LSTM neural network will be described. In the following description, the operations of the layers will be described with reference to the 0^{th} layer. The n^{th} layer may operate in a similar manner as that in the operation of the 0^{th} layer except for receiving the hidden vector hₜⁿ⁻¹ instead of the representation vector ^{x}^{ₜ}.

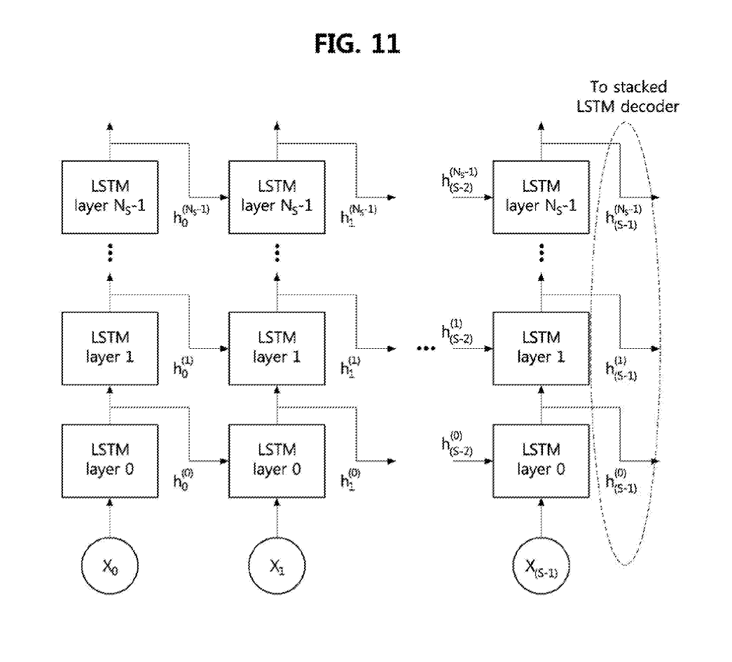

FIG. 10 is a conceptual diagram exemplifying a configuration of an LSTM layer.

Referring to FIG. 10, an LSTM layer may include a forget gate 810, an input gate 850, and an output gate 860. In FIG. 10, a line at the center of the box is a line indicating a cell state of the layer.

The forget gate 810 may calculate fₜ by using a t^{th} representation vector ^{x}ₜ, a previous cell state cₜ₋₁, and a hidden vector hₜ₋₁ with respect to a previous representation vector. The forget gate 810 may determine information which is to be discarded among the existing information and the extent to which the information is discarded during the calculation of fₜ. The forget gate 810 may calculate fₜ using Equation 6.

fₜ=σ(W_{xf}xₜ+w_{hf}h₍ₜ₋₁₎+W_{cf}c₍ₜ₋₁₎+b_{f}) [Equation 6]

In Equation 6, σ denotes a sigmoid function. b_{f} denotes a bias. wₓₜ denotes a weight for ^{x}ₜ, and Wₕₜ denotes a weight for hₜ₋₁, and W_{cf} denotes a weight for cₜ₋₁.

The input gate 850 may determine new information which is to be reflected in the cell state. The input gate 850 may calculate new information to be reflected in the cell state using Equation 7.

iₜ=σ(Wₓᵢxₜ+Wₕᵢh₍ₜ₋₁₎+W_{ci}c₍ₜ₋₁₎+bᵢ) [Equation 7]

In Equation 7, σ denotes a sigmoid function. bᵢ denotes a bias. Wₓᵢ denotes a weight for ^{x}ₜ, and Wₕᵢ denotes a weight for hₜ₋₁, and W_{ci} denotes a weight for cₜ₋₁.

The input gate 850 may calculate a candidate value [symbol] for a new cell state cₜ. The input gate 850 may calculate the candidate value [symbol] using Equation 8.

[symbol]

=tanh(W_{xc}xₜ+W_{hc}h₍ₜ₋₁₎+b_{c}) [Equation 8]

In Equation 8, b_{c} denotes a bias. W_{xc} denotes a weight for xₜ and W_{hc} denotes a weight for hᵢ₋₁.

The cell line may calculate the new cell state cₜ using fₜ, fₜ, and [symbol] .

For example, cₜ may be calculated by Equation 9.

cₜ=fₜ*cₜ₋₁+iₜ* [symbol] [Equation 9]

Referring to Equation 8, Equation 9 may be expressed as Equation 10.

cₜ=fₜc₍ₜ₋₁₎+iₜ tanh(W_{xc}xₜ+w_{hc}h₍ₜ₋₁₎+b_{c}) [Equation 10]

The output gate 860 may calculate an output value using the cell state cₜ. For example, the output gate 860 may calculate the output value according to Equation 11.

oₜ=σ(Wₓₒxₜ+Wₕₒh₍ₜ₋₁₎+W_{co}cₜ+bₒ) [Equation 11]

In Equation 11, σ denotes a sigmoid function. bₒ denotes a bias. Wₓₒ denotes a weight for xₜ, and Wₕₒ denotes a weight for hₜ₋₁, and W_{co} denotes a weight for cₜ.

The LSTM layer may calculate the hidden vector hₜ for the representation vector xₜ using the output value oₜand the new cell state cₜ. For example, hₜ may be calculated according to Equation 12.

hₜ=oₜ tanh(cₜ) [Equation 12]

The LSTM neural network may include an LSTM encoder and an LSTM decoder having a structure symmetrical to the LSTM encoder. The LSTM encoder may receive a first representation vector sequence. The LSTM encoder may receive the first representation vector sequence and output a hidden vector having a predetermined magnitude. The LSTM decoder may receive the hidden vector output from the LSTM encoder. The LSTM decoder may intactly use the same weight matrix and bias value as those used in the LSTM encoder. The LSTM decoder may output a second representation vector sequence corresponding to the first representation vector sequence. In the LSTM decoder, the second representation vector sequence may include estimation vectors corresponding to the representation vectors included in the first representation vector sequence. The LSTM decoder may output the estimated vectors in a reverse order. That is, the LSTM decoder may output the estimated vectors in the reverse order to the order of the representation vectors in the first representation vector sequence.

FIG. 11 is a conceptual diagram illustrating an operation method for the LSTM encoder.

Referring to FIG. 11, the LSTM encoder may sequentially receive the representation vectors of the first representation vector sequence. For example, the LSTM encoder may receive the first representation vector sequence x₀, x₁ . . . x_{S-1}. A n^{th} layer of the LSTM encoder may receive an output of a (n−1)^{th} layer. The nth layer may also use a hidden vector hₜ₋₁ⁿ with respect to a previous representation vector xₜ₋₁ to calculate a hidden vector with respect to a t^{th} representation vector.

Upon receiving the last representation vector x_{(S-1)} of the first representation vector sequence, the LSTM encoder may output hidden vectors h_{(S-1)}⁽⁰⁾ to h_{(S-1)}^{(N}^{_{Jhu −1)}}. Here, N_{S} may be the number of layers of the LSTM encoder.

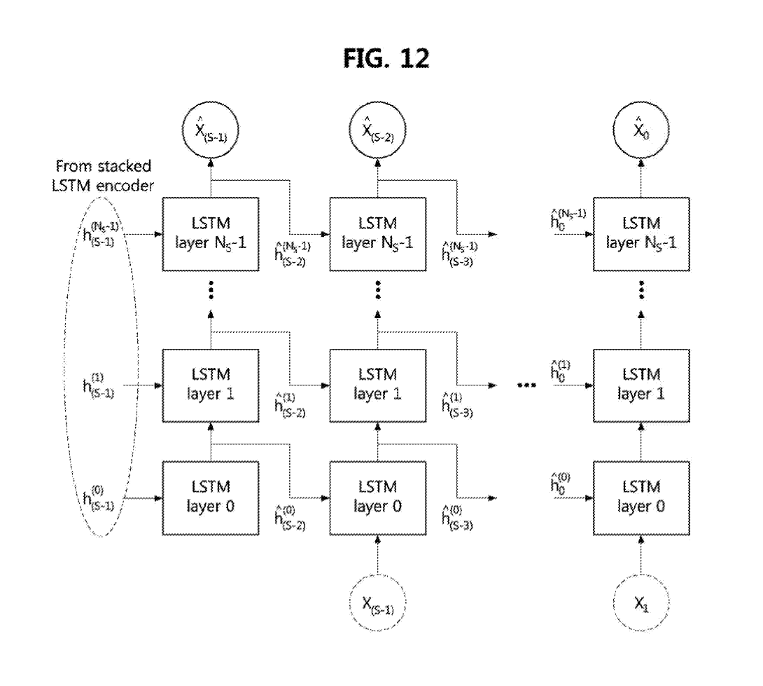

FIG. 12 is a conceptual diagram illustrating an operation method for an LSTM decoder.

The LSTM decoder may receive the hidden vectors h_{(S-1)}⁽⁰⁾ to h_{(S-1)}^{(N}^{_{S}}⁻¹⁾ from the LSTM encoder, and output an estimation vector \hat{x}_{(S-1)} with respect to the representation vector x_{(S-1)}.

The LSTM decoder may output the second representation vector sequence \hat{x}_{(S-1)}, x_{(S-2)}, . . . [symbol] including estimation vectors with respect to the first representation vector sequence x₀, x₁, . . . x_{S-1}. The LSTM decoder may output the estimated vectors in the reverse order (an order reverse to the order of the representation vectors in the first representation vector sequence).

The LSTM decoder may output hidden vectors h_{(S-2)}⁽⁰⁾ to h_{(S-2)}^{(N}^{_{S}}⁻¹⁾ in the process of calcualting \hat{x}_{(S-1)}. After outputting x_{(S-1)}, the LSTM may receive x_{(S-1)}, and may output an estimation vector \hat{x}_{(S-2)} with respect to x_{(S-2)} by using h_{(S-2)}⁽⁰⁾ to ĥ_{(S-2)}^{(N}^{_{S}}⁻¹⁾. The LSTM decoder may only use ĥ_{(S-2)}⁰ to ĥ_{(S-2)}^{(N}^{_{S}}⁻¹⁾ when calculating \hat{x}_{(S-2)}. That is, the LSTM decoder may not receive x_{(S-1)} in the process of calculating \hat{x}_{(S-2)}.

When the LSTM decoder outputs the second representation vector sequence \hat{x}_{(S-1)}, \hat{x}_{(S-2)}, . . . \hat{x}₀, the processor 110 may compare the second representation vector sequence with the first representation vector sequence. For example, the processor 110 may determine whether the session is abnormal using Equation 13.

$$\frac{1}{S} {\sum }_{t = 0}^{S - 1} {‖ {x}_{t} - \hat{{x}_{t}} ‖}^{2} < δ \qquad [ Equation 13 ]$$

In Equation 13, S denotes the number of messages (a request message or a response message) extracted from the session. xₜ is a representation vector output from a t^{th} message, and \hat{x}ₜ is an estimated vector that is output by the LSTM decoder and corresponds to xₜ. The processor 110 may determine whether a difference between the first representation vector sequence and the second representation vector sequences is smaller than a predetermined reference value δ. When the difference between the first and second representation vector sequences is greater than the reference value δ, the processor 110 may determine that the session is abnormal.

In the above description, an example has been described in which the LSTM neural network includes an LSTM encoder and an LSTM decoder. However, the example embodiment is not limited thereto. For example, the LSTM neural network may directly output an estimated vector.

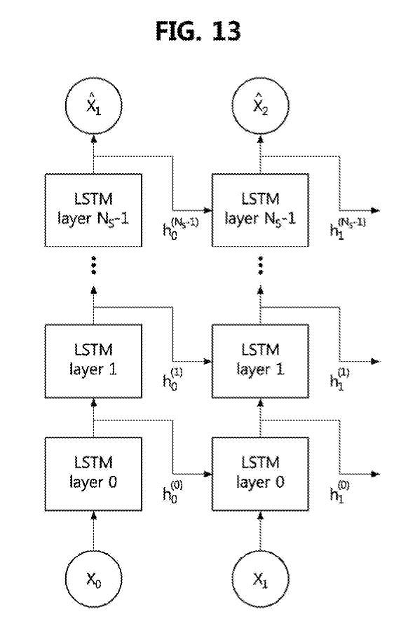

FIG. 13 is a conceptual diagram illustrating an example in which an LSTM neural network directly outputs an estimation vector.

Referring to FIG. 13, the LSTM neural network sequentially receives the representation vectors x₀, x₁, . . . x_{(S-1)} included in the first representative vector sequence, and may output an estimated vector for a representative vector that immediately follows the input representation vector.

For example, the LSTM neural network may receive x₀ and output an estimated vector \hat{x}₁ with respect to x₁. Similarly, the LSTM neural network may receive xₜ₋₁ and output \hat{x}ₜ. The processor 110 may determine whether the session is abnormal based on the difference between the estimation vectors \hat{x}₁, \hat{x}₂, . . . \hat{x}_{S-1} output by the LSTM neural network and the representation vectors x₁, x₂, . . . x_{S-1} received by the LSTM neural network. For example, the processor 110 may use determine whether the session is abnormal using Equation 14.

$$\frac{1}{S - 1} {\sum }_{t = 1}^{S - 1} {‖ {x}_{t} - \hat{{x}_{t}} ‖}^{2} < δ \qquad [ Equation 14 ]$$

The processor 110 may determine whether the difference between the representation vectors x₁, x₂, . . . x_{S-1} and the estimated vectors \hat{x}₁, \hat{x}₂, . . . x_{S-1}, is smaller than a predetermined reference value δ. When the difference is greater than the reference value δ, the processor 110 may determine that the session is abnormal.

In the above description, an example in which the processor 110 determines whether the session is abnormal using the LSTM neural network has been described. However, the example embodiment is not limited thereto. For example, in operation S160, the processor 110 may determine whether the session is abnormal using a gated recurrent unit (GRU) neural network.

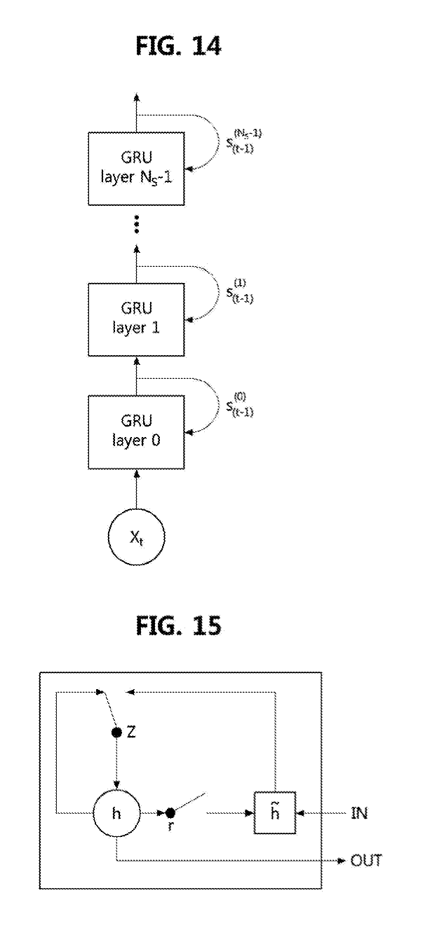

FIG. 14 is a conceptual diagram exemplifying a GRU neural network.

Referring to FIG. 14, the GRU neural network may operate in a similar manner as that in the operation of the LSTM neural network. The GRU neural network may include a plurality of GRU layers. The GRU neural network may sequentially receive representation vectors x₀, x₁, . . . x_{S-1} included in a representation vector sequence. A 0^{th} layer GRU layer 0 of the GRU neural network may receive a t^{th} representation vector xₜ and a hidden vector s₍ₜ₋₁₎⁽⁰⁾ that is output by the 0^{th} layer GRU layer 0 in response to receiving xₜ₋₁. In order to output a hidden vector sₜ⁰ with respect to the t^{th} representation vector xₜ, the 0^{th} layer may use the hidden vector output s₍ₜ₋₁₎⁽⁰⁾ with respect to a previous representation vector. That is, the GRU layer refers to a hidden vector output with respect to a previous representation vector when outputting a hidden vector with respect to an input representation vector, so that a correlation between the representation vectors of the sequence may be considered.

An n^{th} layer may receive sₜⁿ⁻¹ from an (n−1)^{th} layer. As another example, the n^{th} layer may receive sₜⁿ⁻¹ and xₜ from the (n−1)^{th} layer. The n^{th} layer may output a hidden vector sₜⁿ by using a hidden vector sₜ₋₁ⁿ with respect to a previous representation vector and the hidden vector sₜ⁽ⁿ⁻¹⁾ received from the (n−1)^{th} layer.

Hereinafter, an operation of each of the layers of the GRU neural network will be described. In the following description, an operation of the layer will be described with reference to the 0^{th} layer. The n^{th} layer operates in a similar manner as that in the operation of the 0^{th} layer except for receiving the hidden vector output sₜ⁽ⁿ⁻¹⁾ or both the hidden vector output sₜ⁽ⁿ⁻¹⁾ and the representation vector xₜ, instead of receiving the representation vector xₜ.

FIG. 15 is a conceptual diagram exemplifying a configuration of a GRU layer.

Referring to FIG. 15, the GRU layer may include a reset gate r and an update gate z. The reset gate r may determine a method for combining a new input and a previous memory. The update gate z may determine the amount of the previous memory desired to be reflected. Different from the LSTM layer, in the GRU layer, a cell state and an output may be not distinguished from each other.

For example, the reset gate r may calculate a reset parameter r using Equation 15.

r=σ(xₜU^{r}=sₜ₋₁W^{r}) [Equation 15]

In Equation 15, σ denotes a sigmoid function. U^{r} denotes a weight for xₜ, and W^{r} denotes a weight for sₜ₋₁.

For example, the update gate z may calculate a update parameter z using Equation 16.

z=σ(xₜU^{z}+sₜ₋₁W^{z}) [Equation 16]

In Equation 16, σ denotes a sigmoid function. U^{r} denotes a weight for xₜ, and W^{z} denotes a weight for sₜ₋₁.

The GRU layer may calculate an estimated value h for a new hidden vector according to Equation 17.

h=tanh(xₜU^{h}+(sₜ₋₁ ∘ r)W^{h}) [Equation 17]

In Equation 17, σ denotes a sigmoid function. U^{h} denotes a weight for ^{x}^{ₜ}, and W^{h} denotes a weight for sₜ₋₁ ∘ r that is a product of sₜ₋₁ and r.

The GRU layer may calculate a hidden vector sₜ for xₜ by using h calculated in Equation 17. For example, the GRU layer may calculate the hidden vector sₜ for xₜ by using Equation 18.

sₜ=(1−z)∘ h=z ∘ sₜ₋₁ [Equation 18]

The GRU neural network may operate in a similar manner as that in the operation of the LSTM neural network, except for the configuration of each layer. For example, the example embodiments of the LSTM neural network shown in FIGS. 11 to 13 may be similarly applied to the GRU neural network. In the case of a GRU neural network, each layer may operate in a similar manner as in the LSTM neural network, in addition to the operation shown in FIG. 15.

For example, the GRU neural network may include a GRU encoder and a GRU decoder similar to that shown in FIGS. 11 and 12. The GRU encoder may sequentially receive representation vectors x₀, x₁, . . . x_{S-1} of a first representation vector sequence and output hidden vectors s_{(S-1)}⁽⁰⁾ to s_{(S-1)}^{(N}^{ₛ}⁻¹⁾. Here, N_{S} may be the number of layers of the GRU encoder.

The GRU decoder may output a second representation vector sequence \hat{x}_{(S-1)}, \hat{x}_{(S-2)}, . . . [symbol] including estimation vectors with respect to x₀, x₁, . . . x_{S-1}. The GRU decoder may use the same weight matrix and bias value as those used in the GRU encoder as it is. The GRU decoder may output the estimated vectors in the reverse order (a reverse order to the order of the representation vectors in the first representation vector sequence).

The processor 110 may compare the first representation vector sequence with the second representation vector sequence using Equation 13, thereby determining whether the session is abnormal.

As another example, the GRU neural network may not be divided into an encoder and a decoder. For example, the GRU neural network may directly output estimated vectors as described with reference to FIG. 13. The GRU neutral network may receive representation vectors x₀, x₁, . . . x_{S-1} included in a first representative vector sequence, and may output an estimated vector for a representative vector that immediately follows the input representation vector.

The GRU neural network may receive x₀ and output an estimated vector \hat{x}₁ for x₁. Similarly, the GRU neural network xₜ₋₁ may receive and output ^{x}^{ₜ}. The processor 110 may determine whether the session is abnormal based on the difference between the estimation vectors \hat{x}₁, \hat{x}₂, . . . \hat{x}_{S-1} output by the GRU neural network and the representation vectors x₁, x₂, . . . x_{S-1} received by the GRU neural network. For example, the processor 110 may determine whether the session is abnormal using Equation 14.

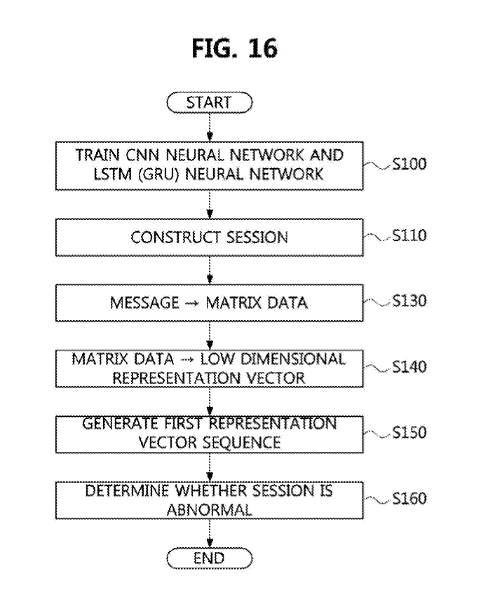

FIG. 16 is a flowchart showing a modified example of a method for detecting an abnormal session performed in the apparatus 100 according to the example embodiment of the present invention.

In the following description of the example embodiment of FIG. 16, details of parts identical to those of FIG. 2 will be omitted.

Referring to FIG. 16, in operation S100, the processor 110 may train the convolutional neural network and the LSTM (or GRU) neural network.

For example, the processor 110 may train the convolutional neural network in an unsupervised learning method. As another example, when training data including messages and output representation vectors labeled on the messages exists, the processor 110 may train the convolutional neural network in a supervised learning method.

In the case of an unsupervised learning, the processor 110 may connect a symmetric neural network having a structure symmetrical to the convolutional neural network to the convolutional neural network. The processor 110 may input the output of the convolutional neural network to the symmetric neural network.

FIG. 17 is a conceptual diagram illustrating a training process of a convolutional neural network.

Referring to FIG. 17, the processor 110 may input the output of the convolutional neural network to the symmetric neural network. The symmetric neural network includes a fully-connected backward layer corresponding to the fully connected layer of the convolutional neural network and a deconvolution layer, and an unpooling layer corresponding to the convolution layer and the pooling layer of the convolutional neural network. The detailed operation of the symmetric neural network is described in Korean Patent Application No. 10-2015-183898.

The processor 110 may update weight parameters of the convolutional neural network on the basis of the difference between an output of the symmetric neural network and an input to the convolutional neural network. For example, the processor 110 may determine a cost function on the basis of at least one of a reconstruction error and a mean squared error between the output of the symmetric neural network and the input to the convolutional neural network. The processor 110 may update the weight parameters in a direction that the cost function determined by the above described method is minimized.

For example, the processor 110 may train the LSTM (GRU) neural network in an unsupervised learning method.

When the LSTM (GRU) neural network includes an LSTM (GRU) encoder and an LSTM (GRU) decoder, the processor 110 may calculate the cost function by comparing representation vectors input to the LSTM (GRU) encoder with representation vectors output from the LSTM (GRU) decoder. For example, the processor 110 may calculate the cost function using Equation 19.

$$J ( θ ) = \frac{1}{Card ( 𝒯 )} {\sum }_{n ∈ 𝒯} {\sum }_{t = 0}^{{S}_{n} - 1} \frac{1}{{S}_{n}} {‖ {x}_{t}^{( n )} - {\hat{x}}_{t}^{( n )} ‖}^{2} \qquad [ Equation 19 ]$$

In Equation 19, J(θ) denotes a cost function value, Card(T) denotes the number of sessions included in training data, Sₙ denotes the number of messages included in an n^{th} training session, xₜ⁽ⁿ⁾ denotes a representation vector corresponding to a t^{th} message of the n^{th} training session, xₜⁿ and denotes an estimated vector output from the LSTM (GRU) decoder, that is, an estimation vector for xₜ⁽ⁿ⁾. In addition, θ denotes a set of weight parameters of the LSTM (GRU) neural network. For example, in the case of a LSTM neural network, θ≡[WₓᵢWₓᵢ, . . . W₀)

The processor 110 may update the weight parameters included in θ in the direction that the cost function J(θ) shown in Equation 19 is minimized.

The methods for detecting an abnormal session according to the example embodiments of the present invention have been described above with reference to FIGS. 1 to 17 and Equations 1 to 19. According to the above-described example embodiments, messages included in a session are transformed into low dimensional representation vectors using a conversational neural network. In addition, a representation vector sequence included in the session is analyzed using the LSTM or GRU neural network, thereby determining whether the session is abnormal. According to the example embodiments, an abnormality of a session is easily determined using an artificial neural network without intervention of a manual task.

As is apparent from the above, messages included in a session are transformed to low dimensional representation vectors using a convolutional neural network. In addition, a representation vector sequence included in the session is analyzed and an abnormality of the session is determined, using an LSTM or GRU neural network. According to example embodiments, it is easily determined whether a session is abnormal using an artificial neural network without an intervention of a manual task.

The methods according to the present invention may be implemented in the form of program commands executable by various computer devices and may be recorded in a computer readable media. The computer readable media may be provided with each or a combination of program commands, data files, data structures, and the like. The media and program commands may be those specially designed and constructed for the purposes, or may be of the kind well-known and available to those having skill in the computer software arts.

Examples of the computer readable storage medium include a hardware device constructed to store and execute a program command, for example, a read-only memory (ROM), a random-access memory (RAM), and a flash memory. The program command may include a high-level language code executable by a computer through an interpreter in addition to a machine language code made by a compiler. The described hardware devices may be configured to act as one or more software modules in order to perform the operations of the present invention, or vice versa.

While the example embodiments of the present invention and their advantages have been described in detail, it should be understood that various changes, substitutions and alterations may be made herein without departing from the scope of the present invention.

1. A method for detecting an abnormal session including a request message received by a server from a client and a response message generated by the server, the method comprising:
transforming at least a part of messages included in the session into data in the form of a matrix;
transforming the data in the form of the matrix into a representation vector, a dimension of which is lower than a dimension of the matrix of the data, using a convolutional neural network; and
determining whether the session is abnormal by arranging the representation vectors obtained from the messages in an order in which the messages are generated to compose a first representation vector sequence, and analyzing the first representation vector sequence using a long short-term memory (LSTM) neural network,
wherein the determining of whether the session is abnormal includes determining whether the session is abnormal on the basis of a difference between the first representation vector sequence and the second representation vector sequence.

2. The method of claim 1, wherein the transforming of the at least a part of the messages into the data in the form of the matrix includes transforming each of the messages into data in the form of a matrix by transforming a character included in each of the messages into a one-hot vector.

3. The method of claim 1, wherein the LSTM neural network includes an LSTM encoder including a plurality of LSTM layers and an LSTM decoder having a structure symmetrical to the LSTM encoder.

4. The method of claim 3, wherein the LSTM encoder sequentially receives the representation vectors included in the first representation vector sequence and outputs a hidden vector having a predetermined magnitude, and
the LSTM decoder receives the hidden vector and outputs a second representation vector sequence corresponding to the first representation vector sequence.

5. (canceled)

6. The method of claim 4, wherein the LSTM decoder outputs the second representation vector sequence by outputting estimation vectors, each corresponding to one of the representation vectors included in the first representation vector sequence, in a reverse order to an order of the representation vectors included in the first representation vector sequence.

7. The method of claim 1, wherein the LSTM neural network sequentially receives the representation vectors included in the first representation vector sequence and outputs an estimation vector with respect to a representation vector immediately following the received representation vector.

8. The method of claim 7, wherein the determining of whether the session is abnormal includes determining whether the session is abnormal on the basis of a difference between the estimation vector output by the LSTM neural network and the representation vector received by the LSTM neural network.

9. The method of claim 1, further comprising training the convolutional neural network and the LSTM neutral network.

10. The method of claim 9, wherein the convolutional neural network is trained by:
inputting training data to the convolutional neural network;
inputting an output of the convolutional neural network to a symmetric neural network having a structure symmetrical to the convolutional neural network; and
updating weight parameters used in the convolutional neural network on the basis of a difference between the output of the symmetric neural network and the training data.

11. The method of claim 9, wherein the LSTM neural network includes an LSTM encoder including a plurality of LSTM layers and an LSTM decoder having a structure symmetrical to the LSTM encoder, and
the LSTM neural network is trained by:
inputting training data to the LSTM encoder;
inputting a hidden vector output from the LSTM encoder and the training data to the LSTM decoder; and
updating weight parameters used in the LSTM encoder and the LSTM decoder on the basis of a difference between an output of the LSTM decoder and the training data.

12-18. (canceled)
